(19) United States
(12) Patent Application Publication
(10) Pub. No.: US 2026/0317091 A1
(43) Pub. Date: Oct. 15, 2026

(54) FIN STORING AND PICKING MACHINE

(71) Applicant: JDM JINGDA MACHINE (NINGBO) CO., LTD., Ningbo (CN)

(72) Inventors: Xiaolong Zhuge, Ningbo (CN); Feng Zhang, Ningbo (CN)

(73) Assignee: JDM JINGDA MACHINE (NINGBO) CO., LTD., Ningbo (CN)

(21) Appl. No.: 19/106,329

(22) PCT Filed: Sep. 6, 2024
(86) PCT No.: PCT/CN2024/117582

§ 371 Date: Feb. 25, 2025

(30) Foreign Application Priority Data
Dec. 7, 2023 (CN) 202311674236.9

(51) Int. Cl. B65G 57/28

(52) U.S. Cl. CPC B65G 57/28; B65G 2201/022

(57) ABSTRACT

A fin storing and picking machine includes a base, an inner turntable, a rotation driving mechanism, a fin collector, a fin collector lifting mechanism, a discharge mechanism and a fin collector moving mechanism; the inner turntable and the rotation driving mechanism are installed on the base, the inner turntable is connected to the rotation driving mechanism and driven by the rotation driving mechanism to rotate relative to the base; a collection station and a discharge station are arranged on the base, the fin collector lifting mechanism is arranged at the collection station, and the discharge mechanism is arranged at the discharge station; when the fin collector moving mechanism moves the fin collector full of fins from the collection station to the inner turntable, the fin collector rotates 90 degrees, then the inner turntable rotates 180 degrees through the rotation driving mechanism, and then the fin collector moving mechanism moves the fin collector to the discharge station, and then the discharge mechanism discharges a fin stack on the fin collector. It can better produce fins.

### TECHNICAL FIELD

The present disclosure relates to a fin storing and picking machine.

### BACKGROUND

When producing fins for air conditioner heat exchangers, the fins are generally stacked and piled up by a fin collector (also called a stacker, or a fin collecting frame) with a collection needle before the next step of processing.

The fin collector generally includes a support plate, a collection needle mounting plate, a tray, a spacer bush, a guard plate, and a collection needle. Although it can complete the general collection function, it is not convenient to move and cannot rotate. Therefore, it is not flexible enough and has limited functions when used in conjunction with other mechanisms such as fin stamping processing devices and subsequent fin processing devices.

Although the existing fin storing and picking machine can enable the fin collector to rotate simultaneously when moving on the workstation, its structure still needs to be improved.

### SUMMARY

The technical problem to be solved by the present invention is to overcome the above-mentioned defects of the prior art and provide a fin storing and picking machine, which can better produce fins.

The technical solution adopted by the present invention to solve the above technical problem is as follows:

A fin storing and picking machine, comprising a base, an inner turntable, a rotation driving mechanism, a fin collector, a fin collector lifting mechanism, a discharge mechanism and a fin collector moving mechanism,
wherein the inner turntable and the rotation driving mechanism are mounted on the base, the inner turntable is connected to the rotation driving mechanism and driven by the rotation driving mechanism to rotate relative to the base; a collection station and a discharge station are arranged on the base, the fin collector lifting mechanism is arranged at the collection station, and the discharge mechanism is arranged at the discharge station; when the fin collector moving mechanism moves the fin collector full of fins from the collection station to the inner turntable, the fin collector rotates 90 degrees, then the inner turntable rotates 180 degrees through the rotation driving mechanism, and then the fin collector moving mechanism moves the fin collector to the discharge station, and then the discharge mechanism discharges a fin stack on the fin collector.

According to embodiments of the present disclosure, a slide groove is provided on the base, a turntable slide groove communicating with the slide groove is provided on the inner turntable, a guide groove is also provided on the base, a turntable guide groove connected with the guide groove is provided on the inner turntable, a guide shaft is installed on a bottom surface of a bottom plate of the fin collector, the guide shaft is always located in a groove connecting a steering groove with the turntable guide groove, and in a groove connecting the guide groove with the turntable guide groove, and the fin collector moving mechanism has a rotating shaft, and the rotating shaft is always located in a hole of the bottom plate of the fin collector.

According to embodiments of the present disclosure, the fin collector moving mechanism comprises a motor, a gear, a rack, a sliding plate and a rotating shaft, the motor is installed on the inner turntable and connected to the gear, the gear is meshed with the rack, the sliding plate is installed on the rack and located in the slide groove and the turntable slide groove, and its two sides are supported and guided by the slide groove and the turntable slide groove, the rotating shaft is installed on the sliding plate and always located in the hole of the bottom plate of the fin collector; when the motor drives the gear to rotate, the rack drives the sliding plate to move along the slide groove and the turntable slide groove, so that the rotating shaft pulls the fin collector to move to the base or to the inner turntable.

In order to ensure that the fin collector can collect materials smoothly at the collection station, two positioning holes are also provided on the bottom plate, and positioning is achieved by positioning mechanisms, each positioning mechanism comprises a cylinder and a positioning column, the cylinder is installed on the base, and connected to the positioning column, each positioning hole corresponds to one positioning mechanism, and the positioning column can be inserted into or withdrawn from the positioning hole by extension and contraction of a piston rod of the cylinder; when collecting fins, the positioning column is inserted into the positioning hole, and when the fins are fully collected, the positioning column withdraws from the positioning hole.

According to embodiments of the present disclosure, the fin collector lifting mechanism comprises two groups arranged oppositely, each group comprises a support, a movable column, a horizontal driving mechanism, an up-down driving mechanism and a lifting seat; the support is installed on a side of the base or integrated with the base, the horizontal driving mechanism is a cylinder, the cylinder is installed on the support, and its piston rod is connected to the movable column, the up-down driving mechanism comprises a motor, a screw rod and a screw nut, the motor is installed on an upper end of the movable column, and connected to the screw rod, upper and lower ends of the screw rod are rotated by the movable column respectively, the screw nut sleeves outside the screw rod, and is connected to the lifting seat, the movable column and the lifting seat can be driven to move back and forth in a horizontal direction by extension and contraction of a piston rod of the cylinder, the screw rod is driven to rotate by the motor, and the screw nut drives the lifting seat to move up and down.

In order to make the movable column and the lifting seat move smoothly, a guide mechanism for slider and rail is provided between the movable column and the support, the slider is mounted on the movable column, the rail is mounted on the support, and a guide mechanism for slider and rail is also provided between the movable column and the lifting seat, the slider is mounted on the lifting seat, and the rail is mounted on the movable column.

According to embodiments of the present disclosure, the fin collector comprises a bottom plate, collection needle mounting plates, a lifting plate, a flip frame, a straightening plate, a lifting plate guide mechanism, and collection needles; lower ends of the plurality of collection needles are vertically installed on the collection needle mounting plates and spaced apart, and the plurality of collection needles pass through holes of the straightening plate and the flip frame in sequence upward; the collection needle mounting plates are at least two or more and are spaced apart and mounted on the bottom plate; the lifting plate is movably placed above the bottom plate; a plurality of equal height limit blocks are arranged on the bottom plate to limit the lowest position of the lifting plate downward; the flip frame is placed on the lifting plate, and plug holes are arranged on both sides thereof, and the plug holes can be movably connected by inserting a flip plug rod of a flip mechanism; two ends of the straightening plate are placed on the lifting plate, and the straightening plate is provided with through holes for the collection needles to pass through, and the diameter of the through holes is slightly larger than the diameter of the collection needles; the lifting plate guide mechanism comprises a guide rod, a lower end of the guide rod is mounted on the collection needle mounting plate, and an upper end of the guide rod passes through the lifting plate, the straightening plate and the flip frame in sequence.

According to embodiments of the present disclosure, there are multiple collection needle mounting plates, which are respectively mounted on the bottom plate in parallel through their respective adjustment plates. The adjustment plates are provided with multiple positioning holes, and the two ends of the collection needle mounting plates are fixed on the positioning holes. In this way, the relative position between the two collection needle mounting plates can be changed by installing the collection needle mounting plates at different positioning holes, so that the distance between the collection needles installed on the collection needle mounting plates can be changed to adapt to fins of different lengths.

In order to facilitate the adjustment of the position of the collection needle mounting plates, a guide mechanism is also installed between the collection needle mounting plates and the adjustment plates.

According to embodiments of the present disclosure, the guide mechanism is a slider-rail guide mechanism, the slider is installed on the collection needle mounting plate, and the guide rail is installed on the adjustment plate.

In order to better straighten the collection needles, especially when the collection needles are relatively long, an upper straightening plate is also provided. The upper straightening plate is arranged above the straightening plate in parallel to each other, and through holes are also provided on the upper straightening plate for the collection needles to pass through. The upper straightening plate and the straightening plate are kept at a certain distance by a plurality of straightening equal height columns. The straightening equal height columns are arranged between the upper straightening plate and the straightening plate, and the upper ends thereof are connected to the upper straightening plate, and the lower ends thereof are connected to the straightening plate.

According to embodiments of the present disclosure, another guide mechanism is also arranged on the outer side of the flip frame, and such guide mechanism includes another guide rod and a guide sleeve. The lower end of such guide rod is installed on the bottom plate, and a guide sleeve sleeves on said another guide rod, and the guide sleeve is installed on the lifting plate. In this way, the lifting plate can be guided by the guide rod and said another guide rod to move up and down more smoothly.

According to embodiments of the present disclosure, said another guide rod has two spaced apart guide rods, and the two guide rods are connected by a connecting plate, so that the guiding accuracy is better.

According to embodiments of the present disclosure, the flip frame is also provided with a plurality of reinforcing ribs, and the installation positions of the plurality of reinforcing ribs are based on the principle of non-interference with the collection needles and the guide rods, thereby increasing the strength of the flip frame and ensuring the smooth lifting and flipping of the fin stack.

In order to facilitate the discharging of the fin stack, after the collection is completed, each row of fins generally needs to be inserted with several positioning steel needles, so several of the installation positions of the plurality of reinforcing ribs are consistent with the insertion positions of the positioning steel needles, and the upper part of these reinforcing ribs is opened with a non-opening groove, so that the steel needles pass through the fin stack from the upper part of the fin stack and the lower part is located in the groove, and is supported by the bottom surface of the reinforcing ribs, so as not to fall on the bottom plate.

The flip frame and the lifting plate are integrated into one through a positioning mechanism. The specific structure of the positioning mechanism is: positioning pins are respectively arranged on both sides of the lifting plate, and positioning pin holes are arranged at the corresponding positions of the flip frame. When the flip frame falls on the lifting plate, the positioning pins on the lifting plate are inserted into the positioning pin holes of the flip frame, thereby ensuring the combination accuracy of the two.

In order to prevent the upper part of the higher fin stack from tilting, a baffle is also provided. The baffle is mounted on the adjustment plate through a support guide rod and a support plate. Both ends of the support plate are also mounted on the adjustment plate, it is also convenient for adjusting the horizontal position of the baffle. The lower end of the support guide rod is mounted on the support plate and passes through the lifting plate and the flip frame upward in sequence. Both ends of the baffle are supported by the support guide rod and movably connected with the support guide rod, it is convenient for adjusting the height of the baffle.

Further, the bottom surface of the bottom plate is provided with a guide shaft that cooperates with the guide groove provided on the base and the inner turntable, and a hole that cooperates with the rotating shaft. The bottom plate is guided by the hole and the guide shaft to rotate around the rotating shaft during movement, thereby realizing that the fin collector rotates when moving in the base station.

According to embodiments of the present disclosure, the discharge mechanism comprises a discharge base, a lifting drive mechanism and a flipping drive mechanism; the discharge base is installed on the base or integrated with the base, and a left column and a right column are respectively arranged on the discharge base; the lifting drive mechanism comprises a motor and a lifting transmission mechanism, the motor is installed on the discharge base, and the motor drives the lifting seat to move up and down through the lifting transmission mechanism; the flipping drive mechanism comprises a motor, a transmission mechanism, a flip frame and flip plug rods, the flip plug rods are installed on the flip frame and arranged at intervals, the flip plug rods correspond to the plug holes on the flip frame of the fin collector; the motor drives the flip frame and the flip plug rods to rotate through the transmission mechanism; a plurality of flip support arms arranged at intervals and installed on the flip frame, and the flip support arms are perpendicular to the axes of the flip plug rods and support the fin stack during flipping.

According to embodiments of the present disclosure, the lifting transmission mechanism comprises screw rods and screw nuts, the screw rods are two screw rods arranged opposite to each other, the upper end of each screw rod is rotatably supported by the left column or the right column, and the lower end is rotatably supported by the discharge base, the screw nut sleeves outside the screw rod, the lifting seat is installed on the screw nut, the motor drives the two screw rods to rotate through an intermediate transmission mechanism, and drives the lifting seat installed thereon to move up and down through their respective screw nuts.

According to embodiments of the present disclosure, the transmission mechanism comprises a driving wheel, a driven wheel, and a chain, the motor and the driving wheel are connected, the driven wheel is rotatably mounted on the lifting seat, one end of the flip frame is connected to the driven wheel and rotates together, and the other end is rotatably connected to the lifting seat, the driving wheel is driven by the motor to rotate, and the driving wheel drives the driven wheel to rotate through the chain, thereby driving the flip frame and the flip plug rods to rotate.

According to embodiments of the present disclosure, the transmission mechanism comprises a motor, a driving gear, and a driven gear, the motor is connected to the driving gear, the driven gear is meshed with the driving gear, both ends of the flip frame are rotatably connected to the lifting seat, one end of the flip frame is connected to a driven gear, and rotates together with the driven gear, the driving wheel drives the driven wheel to rotate, thereby driving the flip frame and the flip plug rods to rotate. Since the fin stack is heavy, in order to make the lifting seat lift smoothly and have sufficient strength when flipping, a lifting seat guide mechanism is also provided between the lifting seat and the left column and between the lifting seat and the right column.

According to embodiments of the present disclosure, the lifting seat guide mechanism is a slider-rail lifting seat guide mechanism, a slider is installed on the lifting seat, and rails are installed on the left column and the right column respectively.

According to embodiments of the present disclosure, the flipping drive mechanism also comprises multiple material baffle plates, and the material baffle plates are driven by a driving element to approach or move away from the fin stack. In this way, when the baffle plate approaches the fin stack, the fin stack can be prevented from tilting.

According to embodiments of the present disclosure, the driving element is a cylinder, the cylinder is mounted on a mounting frame, a piston rod of the cylinder is connected to the material baffle plate, the two ends of the mounting frame are respectively mounted on the left column and the right column, and the material baffle plate can be driven to approach or move away from the fin stack by extension and contraction of the piston rod. In this way, when the baffle plate approaches the fin stack, the fin stack can be prevented from tilting.

Compared with the prior art, the advantage of the present invention is that it can better produce fins.

### BRIEF DESCRIPTION OF THE DRAWINGS

FIG. 1 is a three-dimensional structural schematic view of a fin storing and picking machine in embodiment 1 of the present invention.

FIG. 2 is a three-dimensional structural schematic view of a fin collector of a fin storing and picking machine in embodiment 1 of the present invention.

FIG. 3 is a three-dimensional structural schematic view of a fin collector of a fin storing and picking machine from another perspective in embodiment 1 of the present invention.

FIG. 4 is a three-dimensional structural schematic view of a movable fin collector lifting mechanism of a fin storing and picking machine in embodiment 1 of the present invention.

FIG. 5 is a three-dimensional structural schematic view of a discharge mechanism of a fin storing and picking machine in embodiment 1 of the present invention.

FIG. 6 is a three-dimensional structural schematic view of a discharge mechanism of a fin storing and picking machine from another perspective in embodiment 1 of the present invention.

FIG. 7 is a three-dimensional structural schematic view of a base and related components of a fin storing and picking machine in embodiment 1 of the present invention.

FIG. 8 is a three-dimensional structural schematic view of a flipping drive mechanism of a discharge mechanism of a fin storing and picking machine in embodiment 2 of the present invention.

### DETAILED DESCRIPTION OF EMBODIMENTS

The present invention is further described in detail below in conjunction with the accompanying drawings and embodiments.

### Embodiment 1

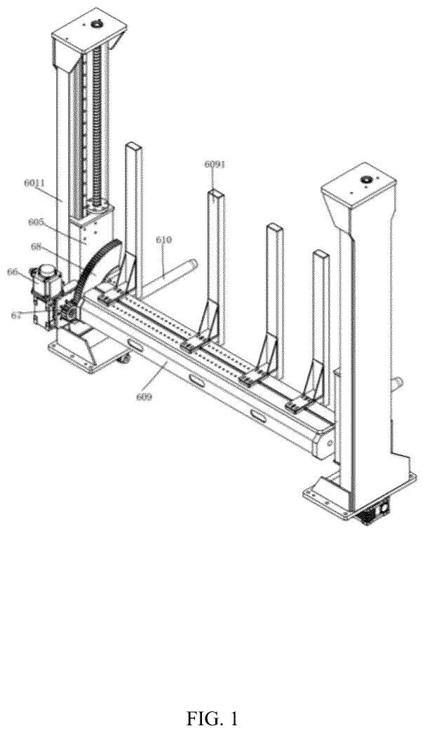

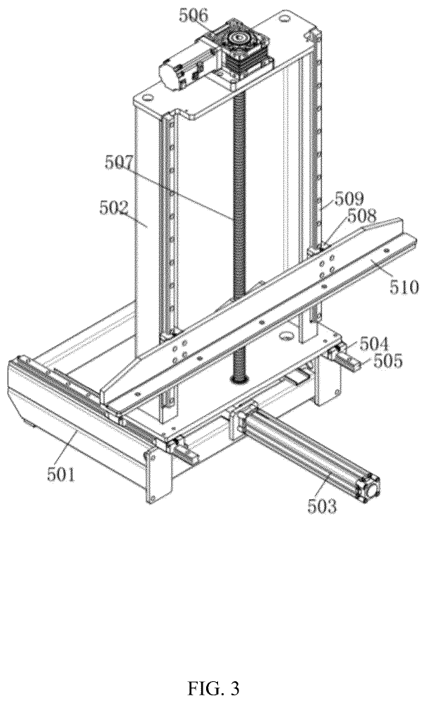

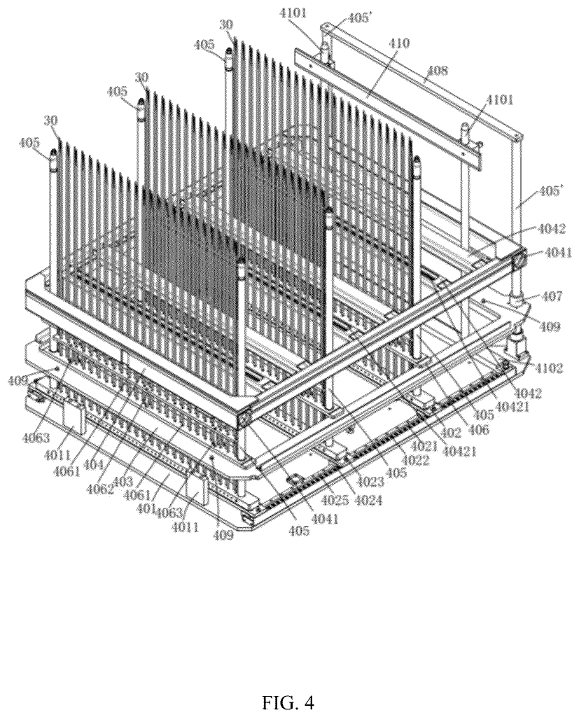

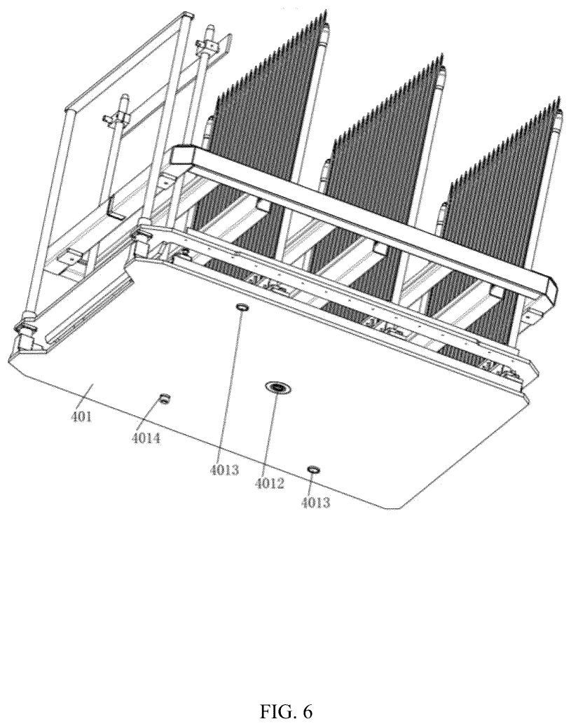

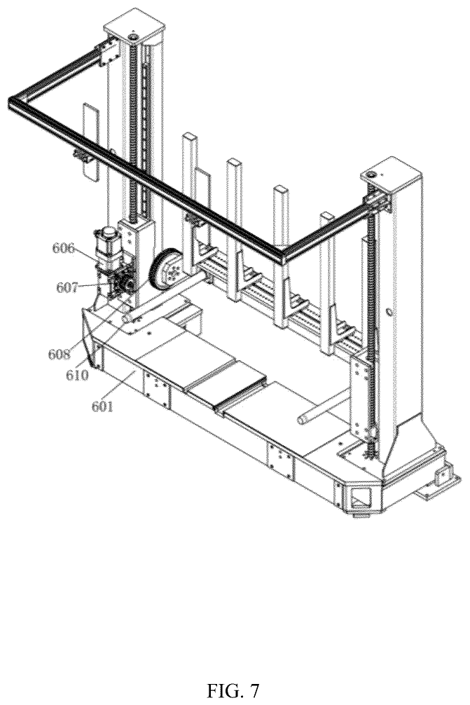

As shown in FIGS. 1-7, a fin storing and picking machine includes a base 1, an inner turntable 2, a rotation driving mechanism, a fin collector (a fin collecting frame) 4, a fin collector lifting mechanism 5, a discharge mechanism 6 and a fin collector moving mechanism.

The inner turntable 2 and the rotation driving mechanism are installed on the base 1, and the inner turntable 2 is connected to the rotation driving mechanism, and the rotation driving mechanism drives the turntable 2 to rotate relative to the base 1 to a set angle.

The rotation driving mechanism is relatively common, as also mentioned in a material collection device in Patent CN202022884059.5, and will not be repeated here.

The base 1 is provided with a collection station and a discharge station, the fin collector lifting mechanism 5 is provided at the collection station, and the discharge mechanism 6 is provided at the discharge station. The fin collector moving mechanism moves the fin collector 4 filled with fins from the collection station to the inner turntable 2. After the inner turntable 2 rotates 180 degrees through the rotation driving mechanism, the fin collector 4 is moved to the discharge station by the fin collector moving mechanism, and then the fin stack on the fin collector 4 is discharged by the discharge mechanism 6.

The fin collector (fin collecting frame) 4 includes a bottom plate 401, collection needle mounting plates 402, a lifting plate (lower support plate) 403, a flip frame (upper support plate) 404, a guide rod 405 and a guide rod 405′, a straightening plate 406, a guide sleeve 407, and collection needles 30.

Multiple collection needles 30 are vertically on the collection needle mounting plates 402 and spaced apart. This structure is common in existing fin collecting frames and will not be described in detail.

The bottom plate 401 is provided with a plurality of equal-height limit blocks 4011 to limit the lowest position of the lifting plate 403 downward, and a hole 4012 is also provided to limit the fin collector 4, and the position of the hole 4012 should be consistent with the rotating shaft 705 described below.

The number of the collection needle mounting plates 402 is at least two or more, which are selected according to the length of the fins. In this embodiment, there are three collection needle mounting plates, which are respectively installed in parallel on the bottom plate 401 through their respective adjustment plates 4021. The adjustment plates 4021 are provided with a plurality of positioning holes 4022, and the two ends of the collection needle mounting plates 402 can be fixed on the positioning holes 4022 by screws 4023. In this way, the relative position between the two collection needle mounting plates 402 can be changed by installing the collection needle mounting plates 402 at different positioning holes 4022, so that the distance between the collection needles 30 correspondingly installed on the collection needle mounting plates 402 can be changed to adapt to fins of different lengths.

In order to facilitate the adjustment of the position of the collection needle mounting plate 402, a slider-rail guide mechanism is also installed between the collection needle mounting plate 402 and the adjusting plate 4021. The slider 4024 is installed on the collection needle mounting plate 402, and the rail 4025 is installed on the adjusting plate 4021.

The lifting plate 403 is movably placed above the bottom plate 401.

The two ends of the straightening plate 406 are placed on the lifting plate 403, and the straightening plate 406 is provided with through holes 4061 for the collection needles 30 to pass through, and the diameter of the through holes 4061 is slightly larger than the diameter of the collection needles 30.

In order to better straighten the collection needle 30, especially when the collection needle is relatively long, an upper straightening plate 4062 is also provided. The upper straightening plate 4062 is arranged parallel to the upper side of the straightening plate 406, and through holes 4061 are also provided thereon for the collection needles 30 to pass through. The upper straightening plate 4062 and the straightening plate 406 are kept at a certain distance by a plurality of equal height columns 4063. The equal height columns 4063 are arranged between the upper straightening plate 4062 and the straightening plate 406, and the upper end thereof is connected to the upper straightening plate 4062, and the lower end thereof is connected to the straightening plate 406.

The lower ends of the collection needles 30 are mounted on the collection needle mounting plate 402, and pass through the through holes 4061 of the straightening plate 406, the through holes 4061 of the upper straightening plate 4062, and the flip frame 404 in sequence.

In order to make the lifting plate 403 move smoothly, a guide mechanism is also provided, the guide mechanism includes a guide rod 405, the lower end of the guide rod is mounted on the collection needle mounting plate 402, and the upper end of the guide rod passes through the lifting plate 403, the straightening plate 406 and the flip frame 404 in sequence, so that the lifting plate 403 can be guided by the guide rod 405 when it moves up and down.

Another guide mechanism is also provided on the outer side of the flip frame 404, and said another guide mechanism includes another guide rod 405′ and a guide sleeve 407. The lower end of said another guide rod 405′ is mounted on the bottom plate 401, and the guide sleeve 407 sleeves the guide rod, and the guide sleeve 407 is mounted on the lifting plate 403.

In this way, the lifting plate 403 can be guided up and down smoothly by the guide rod 405 and said another guide rod 405′.

In this embodiment, there are two other guide rods 405′ arranged at intervals, and the two guide rods 405′ are connected by a connecting plate 408, so that the guiding accuracy is better.

The flip frame 404 is placed on the lifting plate 403, and has plug holes 4041 on both sides. The plug holes 4041 can be inserted into the flip plug rod 610 of the flip mechanism 6 described below and are movably connected. The flip frame 404 is also provided with a plurality of reinforcing ribs 4042. The installation position of the plurality of reinforcing ribs 4042 is based on the principle of not interfering with the collection needles 30 and the guide rod 405, thereby increasing the strength of flip frame 404 and ensuring the smooth lifting and flipping of the fin stack.

In order to facilitate the unloading of the fin stack, after the collection is completed, several positioning steel pins are generally inserted into each row of fins, so several of the installation positions of the above-mentioned multiple reinforcing ribs 4042 are consistent with the insertion positions of the positioning steel needles, and the upper part of these reinforcing ribs 4042 is opened with a non-opening groove 40421, so that the steel needles pass through the fin stack from the upper part of the fin stack and the lower part is located in the groove 40421, and is supported by the bottom surface of the reinforcing ribs 4042, so as not to fall on the bottom plate 401.

The flip frame 404 and the lifting plate 403 are integrated into one by a positioning mechanism. The specific structure of the positioning mechanism in this embodiment is: positioning pins 409 are respectively provided on both sides of the lifting plate 403, and positioning pin holes are provided at the corresponding positions of the flip frame 404. When the flip frame 404 falls on the lifting plate 403, the positioning pins 409 on the lifting plate 403 are inserted into the positioning pin holes of the flip frame 404, thereby ensuring the combination accuracy of the two.

In order to prevent the upper part of the higher fin stack from tilting, a baffle 410 is also provided. The baffle 410 is installed on the adjustment plate 4021 through the support guide rod 4101 and the support plate 4102. The two ends of the support plate 4102 are also installed on the adjustment plate 4021, which is also convenient for adjusting the horizontal position of the baffle 410. The lower end of the support guide rod 4101 is installed on the support plate 4102, and passes through the lifting plate 403 and the flip frame 404 upward in sequence. The two ends of the baffle 410 are supported by the support guide rod 4101 and can be movably connected with the support guide rod 4101, which is convenient for adjusting the height of the baffle 410.

The base 1 is provided with a slide groove 101, and the inner turntable 2 is provided with a turntable slide groove 201 that communicates with the slide groove 101.

The fin collector moving mechanism includes a motor 701, a gear 702, a rack 703, a sliding plate 704 and a rotating shaft 705. The motor 701 is installed on the inner turntable 2 and connected to the gear 702. The gear 702 is meshed with the rack 703. The sliding plate 704 is installed on the rack 703 and located in the slide groove 101 and the turntable slide groove 201. Its two sides are supported and guided by the slide groove 101 and the turntable slide groove 201. The rotating shaft 705 is installed on the sliding plate 704 and is always located in the hole 4012 of the bottom plate 401 of the fin collector 4 described below. In this way, when the motor 701 drives the gear 702 to rotate, the rack 703 drives the sliding plate 704 to move along the slide groove 101 and the turntable slide groove 201, so that the rotating shaft 705 pulls the fin collector 4 to move to the base 1 or to the inner turntable 2.

In order to make the fin collector 4 move smoothly when changing positions between the inner turntable 2 and the base 1, and to make the fin collector 4 rotate 90 degrees during the process of changing positions to facilitate unloading or meet other design requirements, the base 1 is also provided with a turning groove 102 and a guide groove 103. The curve of the turning groove 102 is designed to ensure that the fin collector 4 rotates around the rotating shaft 705 at the required angle, and the inner turntable 2 is provided with a turntable guide groove 202 connected to the turning groove 102 and the guide groove 103 respectively.

The guide shaft 4014 is installed on the bottom surface of the bottom plate 401 of the fin collector 4, it cooperates with the turning groove 102 on the base and the turntable guide groove 202 on the turntable, and is always located in the groove connecting the turning groove 102 to the turntable guide groove 202, and in the groove connecting the guide groove 103 to the turntable guide groove 202. In this embodiment, the turning groove 102 is set at the collection station, and the guide groove 103 is set at the discharge station. When the fin collector moving mechanism at the collection station moves the fin collector 4 from the base 1 to the inner turntable 2, the fin collector 4 rotates around the rotating shaft 705, and the guide shaft 4014 moves along the turning groove 102 to the turntable guide groove 202. When the fin collector moving mechanism stops moving the fin collector 4, the fin collector 4 is moved from the base to the inner turntable, and at the same time rotates 90 degrees clockwise around the rotating shaft 705. The guide groove 103 at the discharge station only plays the role of smoothly moving the fin collector 4 from the inner turntable 2 to the base 1.

If the fin collector at the collection station does not need to rotate 90 degrees, the specially designed turning groove 102 can be replaced with the guide groove 103; similarly, if the fin collector does not need to rotate 90 degrees at the collection station, but needs to rotate 90 degrees at the discharge station, the position of the turning groove 102 and the position of the guide groove 103 can be exchanged.

In order to ensure that the fin collector 4 can collect materials smoothly at the collection station, two positioning holes 401 are also provided on the bottom plate 401. Positioning is achieved through a positioning mechanism, which includes a cylinder 801 and a positioning column 802. The cylinder 801 is installed on the base 1 and connected to the positioning column 802. Each positioning hole 4013 corresponds to a positioning mechanism. The positioning column 802 can be inserted into or withdrawn from the positioning hole 4013 by the extension and contraction of the piston rod of the cylinder 801. When collecting materials, the positioning column 802 is inserted into the positioning hole 4013. After the collection is fully finished, the positioning column 802 withdraws from the positioning hole 4013.

The fin collector lifting mechanism 5 includes two groups arranged oppositely, each group includes a support 501, a movable column 502, a horizontal drive mechanism, an up-down driving mechanism and a lifting seat 510.

The support 501 is installed on the side of the base 1, and can also be made into one piece with the base 1. The horizontal driving mechanism is a cylinder 503, which is installed on the support 501, and its piston rod is connected to the movable column 502. The up-down driving mechanism includes a motor 506, a screw rod 507 and a screw nut. The motor 506 is installed on the upper end of the movable column 502, and connected to the screw rod 507. The upper and lower ends of the screw rod are rotated by the movable column respectively. The screw nut sleeves outside the screw rod 507 and is connected to the lifting seat 510. Through the extension and contraction of the piston rod of the cylinder 503, the movable column 502 and the lifting seat 510 can be driven to move back and forth in the horizontal direction. The motor 506 drives the screw rod 507 to rotate, so that the screw nut drives the lifting seat 510 to move up and down.

In order to make the movable column 502 and the lifting seat 510 move smoothly, a slider-rail guide mechanism is set between the movable column 502 and the support 501. The slider 504 is installed on the movable column 502, and the rail 505 is installed on the support 501. A slider-rail guide mechanism is also installed between the movable column and the lifting seat 510. The slider 508 is installed on the lifting seat 510, and the rail 509 is installed on the movable column 502.

When preparing to collect materials, the piston rod of the cylinder 503 retracts, the lifting seat 510 is inserted into the bottom of the lifting plate 403, and the lifting plate 403 is supported upward by the up-down driving mechanism, and it rises to the position to start collecting materials. During the collecting process, the up-down driving mechanism drives the lifting seat 510 to descend intermittently. After the collecting is completed, the lifting seat 510 puts the lifting plate 403 back on the bottom plate 401, and then the piston rod of the cylinder 503 extends, so that the lifting seat 510 withdraws from the lifting plate 403 and moves away from the fin collector 4.

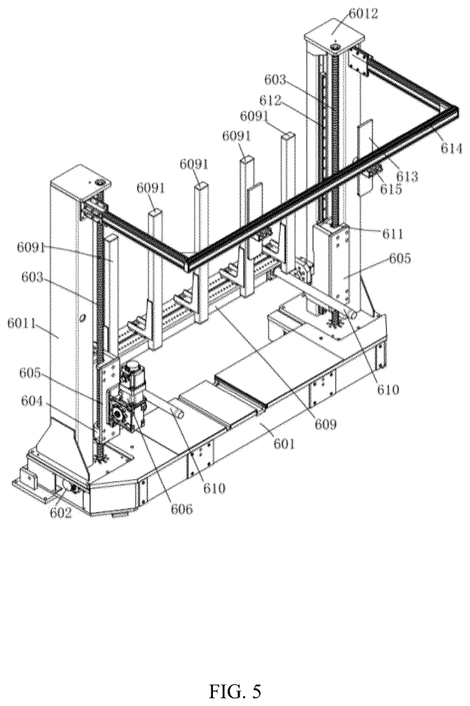

As shown in FIG. 5, the discharge mechanism 6 includes a discharge base 601, a lifting drive mechanism and a flipping drive mechanism.

The discharge base 601 is installed on the base 1, and can also be integrated with the base 1, and a left column 6011 and a right column 6012 are set on it.

The lifting drive mechanism includes a motor 602, a screw rod 603, and a screw nut 604. The motor 602 is installed on the discharge base 601. The screw rod 603 includes two oppositely arranged, and the upper ends of the screw rods are rotatably supported by the left column 6011 and the right column 6012, respectively, and the lower ends are rotatably supported by the discharge base 601. The screw nut 604 is sleeved outside the screw rod 603, and the lifting seat 605 is installed on the screw nut. The motor 602 drives the intermediate transmission mechanism to drive the two screw rods 603 to rotate at the same time, and drives the lifting seat 605 installed thereon to move up and down through the respective screw nuts 604.

Of course, the motor 602 and the intermediate transmission mechanism can also be installed in other places. This embodiment only provides a better structural arrangement. The flipping drive mechanism includes a motor 606, a driving wheel 607, a driven wheel 608, a chain, a flip frame 609 and a flip plug rod 610. The motor 606 and the driving wheel 607, and the driven wheel 608 are rotatably mounted on the lifting seat 605. One end of the flip frame 609 is connected to the driven wheel and rotates together, and the other end is rotatably connected to the lifting seat 605. The flip plug rod 610 is mounted on the flip frame 609 and arranged at intervals, corresponding to the plug hole 4041 on the flip frame 404. The driving wheel 607 is driven to rotate by the motor 606, and the driven wheel 608 is driven to rotate by the chain, thereby driving the flip frame 609 and the flip plug rod 610 to rotate.

A plurality of flip support arms 6091 arranged at intervals are installed on the flip frame 609, and the flip support arms 6091 are perpendicular to the axis of the flip plug rod 610, so that the fin stack can be supported when flipping.

Since the fin stack is heavy, in order to make the lifting seat 605 lift smoothly and have sufficient strength when flipping, a slider-rail guide mechanism is also provided. The slider 611 is installed on the lifting seat 605, and the rails 612 are installed on the left column 6011 and the right column 6012 respectively.

The flipping drive mechanism also includes material baffle plates 613, which are multiple and driven by a driving element. The driving element is a cylinder 615, which is installed on a mounting frame 614, and its piston rod is connected to the material baffle plate 613. The two ends of the mounting frame 614 are respectively installed on the left column 6011 and the right column 6012. The material baffle plate 613 can be driven to approach or move away from the fin stack by the extension and contraction of the piston rod, so that when the material baffle plate 613 approaches the fin stack, the fin stack can be prevented from tilting.

At the discharge station, while the fin collector 4 with the fin stack is moved from the inner turntable 2 to the base 1 by the fin collector moving mechanism, the flip plug rod 610 is gradually inserted into the plug hole 4041 on the flip frame 404 until the fin collector 4 stops moving, and then the lifting drive mechanism drags the flip frame 404 and the fin stack thereon to rise until they are completely separated from the collection needles 30, and the fin collector moving mechanism pushes the remaining parts of the fin collector 4 onto the inner turntable 2 again, and then the lifting drive mechanism drives the flip frame 404 and the fin stack 10 thereon to descend. At the same time, the flipping drive mechanism drives the flip frame 404 and the fin stack thereon to flip 90 degrees through the rotation of the flip frame 609, so that the unloading speed can be increased while descending and flipping. After flipping in place, the material receiving trolley 9 takes away the fin stack, and then the lifting drive mechanism drives the flip frame 404 to rise. At the same time, the flipping drive mechanism drives the flip frame 404 to flip and reset through the rotation of the flip frame 609. After the flip frame 609 stops rising, the remaining parts of the fin collector 4 are moved from the inner turntable 2 to the base 1 by the fin collector moving mechanism. The lifting drive mechanism drives the flip frame 404 to descend and return to the lifting plate 403. The fin collector moving mechanism pushes the entire fin collector 4 back to the inner turntable 2, and the inner turntable 2 rotates 180 degrees back to the collection station to prepare for the next material collection.

### Embodiment 2

The difference between the fin storing and picking machine of this embodiment and Embodiment 1 is only the difference in the flipping drive mechanism, and the other mechanisms are the same as Embodiment 1.

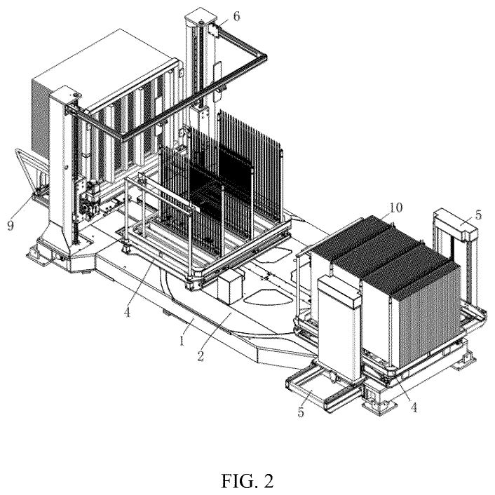

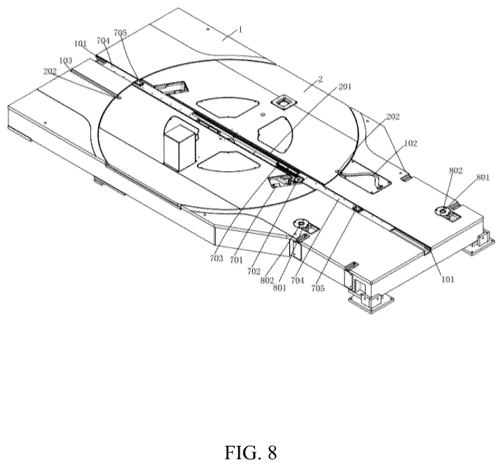

As shown in FIG. 8, the flipping drive mechanism of this embodiment includes a motor 66, a driving gear 67, a driven gear 68, a flip frame 609 and a flip plug rod 610. The motor 66 is connected to the driving gear 67, and the driven gear 68 is meshed with the driving gear 67. Both ends of the flip frame 609 are rotatably connected to the lifting seat 605, and one end of the flip frame 609 is connected to the driven gear 68, and rotates together with the driven gear 68. The flip plug rods 610 are installed on the flip frame 609 and arranged at intervals, corresponding to the plug-in holes 4041 on the flip frame 404 (see FIG. 2). When the flipping drive mechanism is in action, the motor 66 drives the driving gear 67 to rotate, and the driving gear 67 drives the driven gear 68 to rotate, thereby driving the flip frame 609 and the flip plug rod 610 to rotate.

What is claimed is:

1. A fin storing and picking machine, comprising a base, an inner turntable, a rotation driving mechanism, a fin collector, a fin collector lifting mechanism, a discharge mechanism and a fin collector moving mechanism,
wherein the inner turntable and the rotation driving mechanism are mounted on the base, the inner turntable is connected to the rotation driving mechanism and driven by the rotation driving mechanism to rotate relative to the base; a collection station and a discharge station are arranged on the base, the fin collector lifting mechanism is arranged at the collection station, and the discharge mechanism is arranged at the discharge station; when the fin collector moving mechanism moves the fin collector full of fins from the collection station to the inner turntable, the fin collector rotates 90 degrees, then the inner turntable rotates 180 degrees through the rotation driving mechanism, and then the fin collector moving mechanism moves the fin collector to the discharge station, and then the discharge mechanism discharges a fin stack on the fin collector.

2. The fin storing and picking machine according to claim 1, wherein a slide groove is provided on the base, a turntable slide groove communicating with the slide groove is provided on the inner turntable, a guide groove is also provided on the base, a turntable guide groove connected with the guide groove is provided on the inner turntable, a guide shaft is installed on a bottom surface of a bottom plate of the fin collector, the guide shaft is always located in a groove connecting a steering groove with the turntable guide groove, and in a groove connecting the guide groove with the turntable guide groove, and the fin collector moving mechanism has a rotating shaft, and the rotating shaft is always located in a hole of the bottom plate of the fin collector.

3. The fin storing and picking machine according to claim 1, wherein the fin collector moving mechanism comprises a motor, a gear, a rack, a sliding plate and a rotating shaft, the motor is installed on the inner turntable and connected to the gear, the gear is meshed with the rack, the sliding plate is installed on the rack and located in the slide groove and the turntable slide groove, and its two sides are supported and guided by the slide groove and the turntable slide groove, the rotating shaft is installed on the sliding plate and always located in the hole of the bottom plate of the fin collector; when the motor drives the gear to rotate, the rack drives the sliding plate to move along the slide groove and the turntable slide groove, so that the rotating shaft pulls the fin collector to move to the base or to the inner turntable.

4. The fin storing and picking machine according to claim 1, wherein two positioning holes are also provided on the bottom plate, and positioning is achieved by positioning mechanisms, each positioning mechanism comprises a cylinder and a positioning column, the cylinder is installed on the base, and connected to the positioning column, each positioning hole corresponds to one positioning mechanism, and the positioning column can be inserted into or withdrawn from the positioning hole by extension and contraction of a piston rod of the cylinder; when collecting fins, the positioning column is inserted into the positioning hole, and when the fins are fully collected, the positioning column withdraws from the positioning hole.

5. The fin storing and picking machine according to claim 1, wherein the fin collector lifting mechanism comprises two groups arranged oppositely, each group comprises a support, a movable column, a horizontal driving mechanism, an up-down driving mechanism and a lifting seat; the support is installed on a side of the base or integrated with the base, the horizontal driving mechanism is a cylinder, the cylinder is installed on the support, and its piston rod is connected to the movable column, the up-down driving mechanism comprises a motor, a screw rod and a screw nut, the motor is installed on an upper end of the movable column, and connected to the screw rod, upper and lower ends of the screw rod are rotated by the movable column respectively, the screw nut sleeves outside the screw rod, and is connected to the lifting seat, the movable column and the lifting seat can be driven to move back and forth in a horizontal direction by extension and contraction of a piston rod of the cylinder, the screw rod is driven to rotate by the motor, and the screw nut drives the lifting seat to move up and down.

6. The fin storing and picking machine according to claim 5, wherein a guide mechanism for slider and rail is provided between the movable column and the support, the slider is mounted on the movable column, the rail is mounted on the support, and a guide mechanism for slider and rail is also provided between the movable column and the lifting seat, the slider is mounted on the lifting seat, and the rail is mounted on the movable column.

7. The fin storing and picking machine according to claim 1, wherein the fin collector comprises a bottom plate, collection needle mounting plates, a lifting plate, a flip frame, a straightening plate, a lifting plate guide mechanism, and collection needles; lower ends of the plurality of collection needles are vertically installed on the collection needle mounting plates and spaced apart, and the plurality of collection needles pass through holes of the straightening plate and the flip frame in sequence upward; the collection needle mounting plates are at least two or more and are spaced apart and mounted on the bottom plate; the lifting plate is movably placed above the bottom plate; a plurality of equal height limit blocks are arranged on the bottom plate to limit the lowest position of the lifting plate downward; the flip frame is placed on the lifting plate, and plug holes are arranged on both sides thereof, and the plug holes can be movably connected by inserting a flip plug rod of a flip mechanism; two ends of the straightening plate are placed on the lifting plate, and the straightening plate is provided with through holes for the collection needles to pass through, and the diameter of the through holes is slightly larger than the diameter of the collection needles; the lifting plate guide mechanism comprises a guide rod, a lower end of the guide rod is mounted on the collection needle mounting plate, and an upper end of the guide rod passes through the lifting plate, the straightening plate and the flip frame in sequence.

8. The fin storing and picking machine according to claim 1, wherein the discharge mechanism comprises a discharge base, a lifting drive mechanism and a flipping drive mechanism; the discharge base is installed on the base or integrated with the base, and a left column and a right column are respectively arranged on the discharge base; the lifting drive mechanism comprises a motor and a lifting transmission mechanism, the motor is installed on the discharge base, and the motor drives the lifting seat to move up and down through the lifting transmission mechanism; the flipping drive mechanism comprises a motor, a transmission mechanism, a flip frame and flip plug rods, the flip plug rods are installed on the flip frame and arranged at intervals, the flip plug rods correspond to the plug holes on the flip frame of the fin collector; the motor drives the flip frame and the flip plug rods to rotate through the transmission mechanism; a plurality of flip support arms arranged at intervals and installed on the flip frame, and the flip support arms are perpendicular to the axes of the flip plug rods and support the fin stack during flipping.

9. The fin storing and picking machine according to claim 8, wherein the lifting transmission mechanism comprises screw rods and screw nuts, the screw rods are two screw rods arranged opposite to each other, the upper end of each screw rod is rotatably supported by the left column or the right column, and the lower end is rotatably supported by the discharge base, the screw nut sleeves outside the screw rod, the lifting seat is installed on the screw nut, the motor drives the two screw rods to rotate through an intermediate transmission mechanism, and drives the lifting seat installed thereon to move up and down through their respective screw nuts.

10. The fin storing and picking machine according to claim 8, wherein the transmission mechanism comprises a driving wheel, a driven wheel, and a chain, the motor and the driving wheel are connected, the driven wheel is rotatably mounted on the lifting seat, one end of the flip frame is connected to the driven wheel and rotates together, and the other end is rotatably connected to the lifting seat, the driving wheel is driven by the motor to rotate, and the driving wheel drives the driven wheel to rotate through the chain, thereby driving the flip frame and the flip plug rods to rotate.

11. The fin storing and picking machine according to claim 8, wherein the transmission mechanism comprises a motor, a driving gear, and a driven gear, the motor is connected to the driving gear, the driven gear is meshed with the driving gear, both ends of the flip frame are rotatably connected to the lifting seat, one end of the flip frame is connected to a driven gear, and rotates together with the driven gear, the driving wheel drives the driven wheel to rotate, thereby driving the flip frame and the flip plug rods to rotate.

12. The fin storing and picking machine according to claim 8, wherein a lifting seat guide mechanism is provided between the lifting seat and the left column and between the lifting seat and the right column.

13. The fin storing and picking machine according to claim 12, wherein the lifting seat guide mechanism is a slider-rail lifting seat guide mechanism, a slider is installed on the lifting seat, and rails are installed on the left column and the right column respectively.

14. The fin storing and picking machine according to claim 8, wherein the flipping drive mechanism also comprises multiple material baffle plates, and the material baffle plates are driven by a driving element to approach or move away from the fin stack.

15. The fin storing and picking machine according to claim 14, wherein the driving element is a cylinder, the cylinder is mounted on a mounting frame, a piston rod of the cylinder is connected to the material baffle plate, the two ends of the mounting frame are respectively mounted on the left column and the right column, and the material baffle plate can be driven to approach or move away from the fin stack by extension and contraction of the piston rod.
